(19) United States
(12) Patent Application Publication
(10) Pub. No.: US 2012/0013445 A1
(43) Pub. Date: Jan. 19, 2012

(54) IC TAG CONTROL METHOD AND APPARATUS

(76) Inventor: Junichi Yasuda, Tokyo (JP)

(21) Appl. No.: 13/058,084

(22) PCT Filed: Sep. 9, 2009
(86) PCT No.: PCT/JP2009/065744

§ 371 Date: Feb. 8, 2011

(30) Foreign Application Priority Data
Sep. 11, 2008 (JP) 2008-233059

(51) Int. Cl. G06K 7/01

(52) U.S. Cl. 340/10.1

(57) ABSTRACT

A data processing unit (113) divides received user data by a division number s into n-byte divided user data and stores them in a data buffer (115). A data processing unit (113) generates Header information concerning the divided user data and stores them in the data buffer (115). The data processing unit (113) puts each divided user data and corresponding generated Header information together to form tag storage user data. An RW control unit (116) writes tag storage user data associated with a tag ID in the user memory (142) of a detected RFID tag (104).

### TECHNICAL FIELD

The present invention relates to a method and apparatus for controlling an IC tag such as an RFID tag to be used to, for example, identify an article.

### BACKGROUND ART

There have been developed many communication control systems using an IC card or an IC tag (reference 1: Japanese Patent Laid-Open No. 2004-280754, reference 2: Japanese Patent Laid-Open No. 2005-141529, and reference 3: Japanese Patent Laid-Open No. 2006-023962). Under these circumstances, an RFID (Radio Frequency IDentification) tag is used as one of the IC tags. RFID tags are assigned IDs (identifiers), respectively, and used for the application purpose of, for example, individually identifying articles. The RFID tags can communicate with a device called a reader/writer (to be referred to as an RW hereinafter) using a wireless communication technology so as to exchange the IDs or data.

FIG. 14 is a view showing an example of the arrangement of a system using RFID tags. Communication between an RFID tag and an RW uses a wireless technology. This wireless transmission basically uses a shared bus type transmission scheme. When a plurality of RFID tags 1, 2, and 3 communicate with the RW, collision readily occurs. Hence, the communication between the RFID tags and the RW is fundamentally done as one-to-one communication, as shown in FIG. 14. Simultaneous communication with other RFID tags is impossible.

In addition, full-duplex communication between one

RFID tag and the RW is also impossible. As shown in FIG. 15, one-way communication is performed continuously on different time bases, thereby implementing two-way communication between the RW and the RFID tag.

Especially, a passive type RFID tag receives power from the RW and thus has difficulty in performing high-speed data communication. The maximum logical speed-of “ISO15693” is 26 Kbps. This is merely a transmission rate, and the actually transmittable data amount is smaller. It is therefore important to decrease the communication amount between the RFID tag and the RW to attain efficient data exchange.

To identify an RFID tag itself, a tag ID is used. Tag IDs are identifiers to distinguish RFID tags. A unique ID is assigned to each RFID tag standard. Data write/read of an RFID tag is done by designating the RFID tag using its tag ID. According to the general standard of the RFID tag having the tag ID, the storage capacity is 64 to 256 bits for the tag ID area and 100 to 400 bytes or more for the user memory area, as shown in FIG. 16. The RFID tag standard is defined by an international standard such as “ISO15693” or “EPCglobal”. Not only the tag ID but also a data area called a user memory or a user area is defied in the RFID tag.

A user who uses an RFID tag can store arbitrary data in its user memory. The user can write/read necessary data in/from the user memory using the RW so as to utilize the necessary data.

The size (storage capacity) of the tag ID is usually 64 to 258 bits. On the other hand, the user memory has a capacity of 100 bytes or more. Recently available is an RFID tag having a user memory of 4,000 bytes or more. The user memory serving as a mass data area stores a delivery number, barcode data, history information, image data, and the like and is thus used in business.

RFID tags having different tag IDs can be applied to components or articles and used to manage the individual items. In, for example, the distribution field, the RFID tags are used to collectively manage warehousing/retrieval of a plurality of articles.

An example will be explained in which RFID tags are used for warehousing/retrieval management of individual articles among a plurality of companies. Generally, as shown in FIG. 17, a pharmaceutical company confirms taking articles (medicaments) out of a warehouse and then ships them, and a store confirms warehousing after arrival of the articles. The following operations are done in this procedure.

1. An order of medicaments from the store arrives at the pharmaceutical company.

2. The pharmaceutical company makes an order slip, completes the numbers and kinds of medicaments based on the order slip, and then ships them.

3. The store confirms, based on the order slip, the correctness of the numbers and kinds of medicaments that have arrived, and receives them.

In the above-described warehousing/retrieval procedure, attaching an RFID tag to each target article makes it possible to collectively identify the numbers and kinds of articles on transaction from a remote site using an RW (reader/writer). For example, as shown in FIG. 18, batch-reading RFID tags using a gate type RW at the time of shipment from the pharmaceutical company allows easy matching between the medicaments to be shipped and the contents of the slip in shipment confirmation. When the medicaments have then arrived at the store, an RW reads the information of the attached RFID tags so as to easily confirm warehousing by collation with the contents of the slip. Shipment or arrival of wrong articles that are not on order can also be detected immediately.

In general, information to be used to check shipment or reception is passed in the form of paper slip. However, when the user memory of each RFID tag holds (stores) the information of the order slip and the like, the user can simultaneously check the order contents and the articles using the RFID tags.

An example of utilization of RFID tags has been described above in which the order contents and the numbers and kinds of shipped articles can be confirmed automatically at the time of shipment and reception.

Commercial transaction monument using RFID tags is also applicable to a sales form via a distribution company. For example, a case will be described in which medicaments are transported from a pharmaceutical company to stores via a distribution company, as shown in FIG. 19. As shown in FIG. 19, actual medicaments pass through a number of companies. In addition, medicaments of the same order contents may arrive at different stores, or medicaments of different order contents may simultaneously arrive at a single store. For this reason, the RFID tags need to individually hold (store) not only the data of individual medicaments but also general information (for example, information of the order contents or slip) representing the individual medicaments.

As is apparent from the above description, for example, to comply with a more complex distribution form, it is important to make more pieces of information available. For this purpose, it is important to allow the user memory of an RFID tag to store more pieces of information. When data storable in the user memory increases, more detailed check or utilization for other than check becomes possible. For example, storing image data of an order slip enables to store information a man can easily confirm. When image information of a barcode or the like is stored, the barcode can be printed on the site.

As described above, data to be stored in the user memory of an RFID tag tends to increase.

### DISCLOSURE OF INVENTION

### Problem to be Solved by the Invention

As described above, using RFID tags makes it possible to automate and simplify recognition and confirmation of articles on transaction. However, if a large quantity of information such as image data is stored in the user memory of an RFID tag, the following problems arise.

First, data read takes time.

For detailed article management, data to be stored in the user memory of an RFID tag needs to increase. For example, more pieces of information including the order date/time, numbers and kinds of articles, barcode, shipment date/time, and image data as well as the slip number are stored, problems of each article can easily be detected.

However, when the user memory stores a large quantity of data, the communication time of the RFID tag prolongs. The communication speed between the RFID tag and the RW is limited. Simultaneous communication with a plurality of RFID tags is impossible because of the characteristics of wireless communication. For these reasons, when handling a large quantity of data, the RW needs longer time for RFID tag detection and data read/write. In this case, loads stand by at the RW until it reads the IDs and all data of the RFID tags of all loads for confirmation, and the advantage of shortening time of batch read lessens.

Second, the RFID tag read accuracy degrades.

Communication between the RFID tag and the RW which uses a wireless technology is readily affected by noise and reflection of radio waves. For this reason, when a large quantity of data is transmitted/received to/from each of a lot of RFID tags, the probability that an error occurs in data communication of the RFID tag itself increases.

To confirm individual articles, communication with all RFID tags is necessary. When the time of communication with an RFID tag is longer, time for communication with the remaining RFID tags runs out. For example, when detecting moving articles on a belt conveyor or the like, taking long time for data read from the RFID tag of an article may lead to passage of the next article before reading data.

For this reason, if the data communication time of an RFID tag itself becomes longer, the probability that an error occurs increases. If an error occurs, an operation of confirming the RFID tag itself is required, and the advantage of shortening time and improving the accuracy is eventually lost.

Third, the data storage efficiency lowers.

To use user data, various kinds of data need to be stored in the user memory of an RFID tag. However, the data itself is often the same among a plurality of RFID tags, and the data is repetitively written in the RFID tags.

For example, when order contents represent 100 medicaments, 100 RFID tags hold the same order slip contents. When directly storing the data in the user memory of each RFID tag, 100 identical data are written in the user memories of the RFID tags, and the same contents are read 100 times for confirmation.

To solve this problem, it is necessary to reduce the amount and time of communication between each RFID tag and the RW and also perform communication with all RFID tags, although the amount of user data itself in the RFID tag increases. To accomplish this, for example, data necessary for confirmation is acquired using another method such as a network instead of storing the above-described data in the user memory of each RFID tag. For example, the tag ID is used as a key, and data itself including order contents is acquired using a network.

However, this method requires costly network environment preparation. For example, it is necessary to prepare a network environment such as a wireless LAN in warehouses where articles are stored or received, and construct a network or make an agreement to refer to data in another company. This poses a new problem such as an extra cost.

The present invention has been made to solve the above-described problems, and has as its object to enable to handle a larger quantity of information without decreasing the speed and accuracy of communication with an IC tag such as an RFID tag.

### Means of Solution to the Problem

An IC tag control method according to the present invention comprises at least the first step of dividing set original data by a preset division number to generate a plurality of divided data, the second step of creating a tag information list including a plurality of correspondence relations that associate the divided data with a plurality of preset tag IDs, and the third step of transmitting all the divided data to IC tags having corresponding tag IDs based on the tag information list.

An IC tag control apparatus according to the present invention comprises at least data processing means for dividing original data set in a setting registration unit by a preset division number to generate a plurality of divided data, and creating a tag information list including a plurality of correspondence relations that associate the divided data with a plurality of preset tag IDs, and reader/writer control means for transmitting all the divided data to IC tags having corresponding tag IDs based on the tag information list.

### Effect of the Invention

As described above, according to the present invention, since original data is divided and transmitted to a tag ID, it is possible to handle a larger quantity of information without decreasing the speed and accuracy of communication with an IC tag such as an RFID tag.

### BRIEF DESCRIPTION OF DRAWINGS

FIG. 1A is a block diagram showing the arrangement of a system for implementing an IC tag control method according to the first exemplary embodiment of the present invention;

FIG. 1B is a view showing the structure of user data 150;

FIG. 1C is a view showing the structure of tag storage user data 153;

FIG. 2 is a block diagram showing the arrangement of a system for implementing an IC tag control method according to the second exemplary embodiment of the present invention;

FIG. 3A is a view for explaining division of user data 250;

FIG. 3B is a view showing the structure of tag storage user data 253;

FIG. 4 is a view showing a structure of setting information held by a setting registration unit 111;

FIG. 5 is a flowchart for explaining an operation concerning division;

FIG. 6 is a flowchart for explaining an operation concerning reconstruction;

FIG. 7A is a view showing the structure of user data 400;

FIG. 78 is a view for explaining division of user data 400;

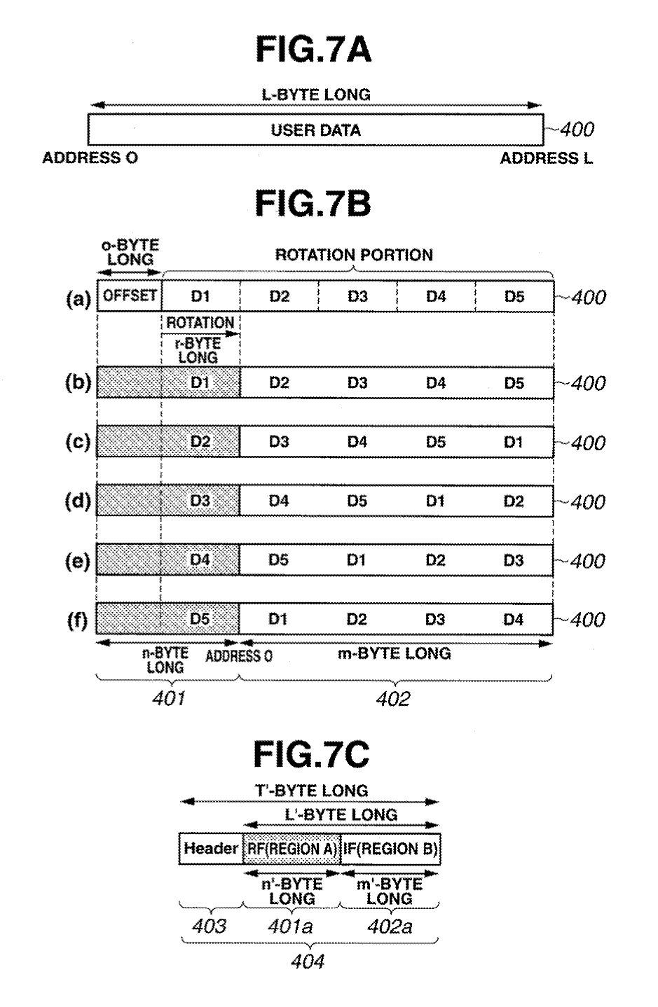

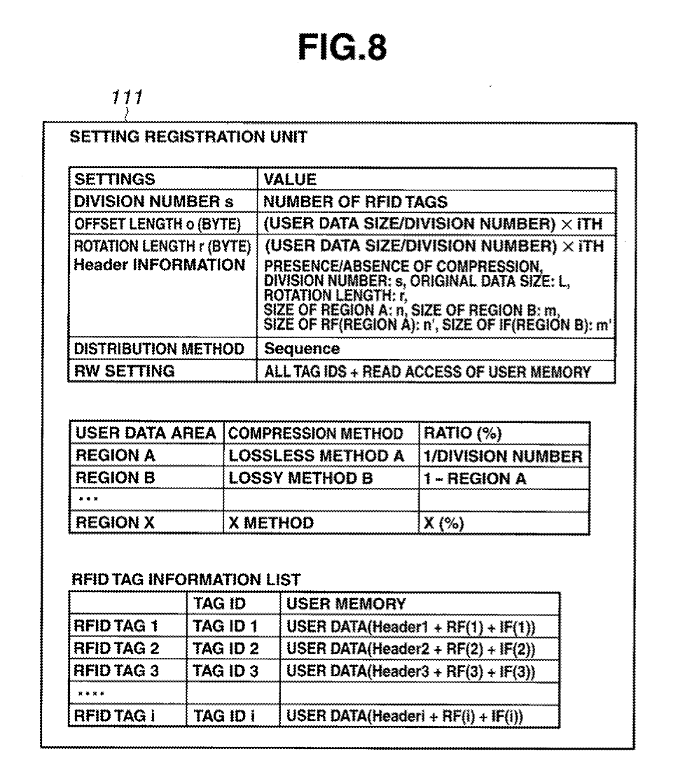

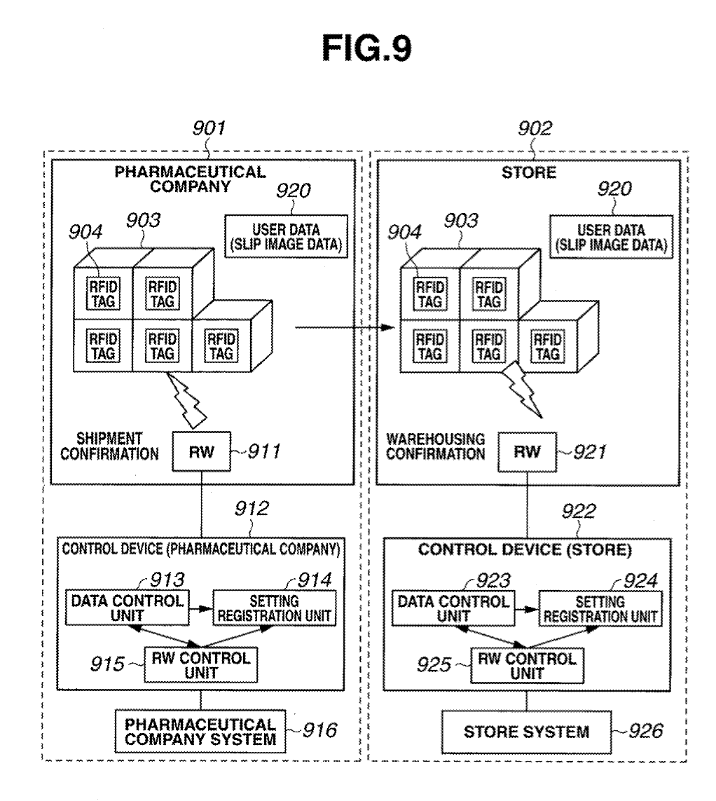

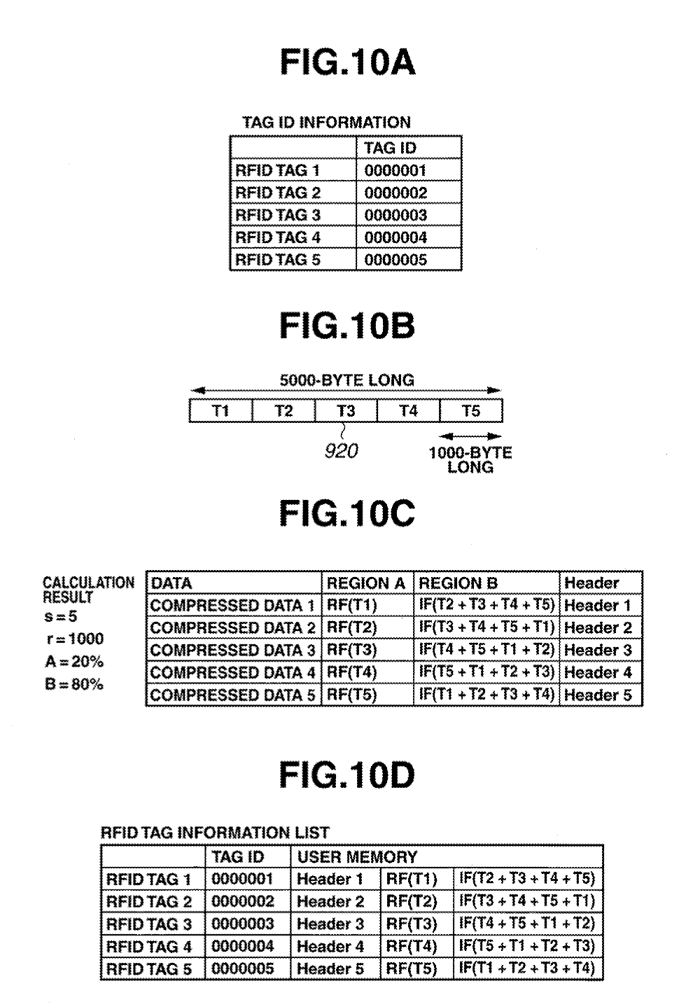

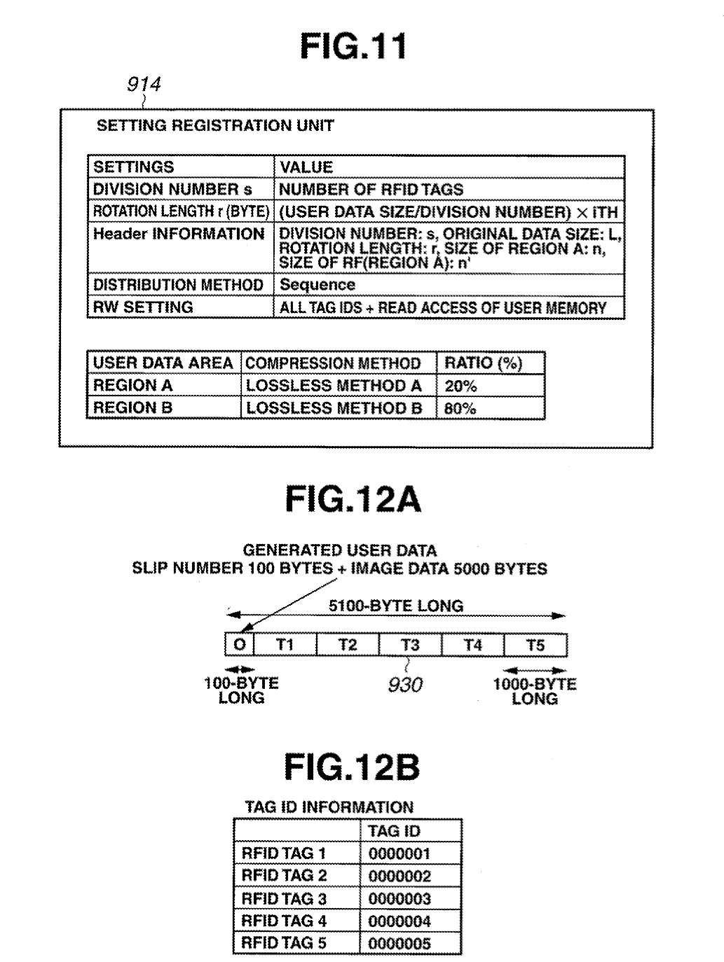

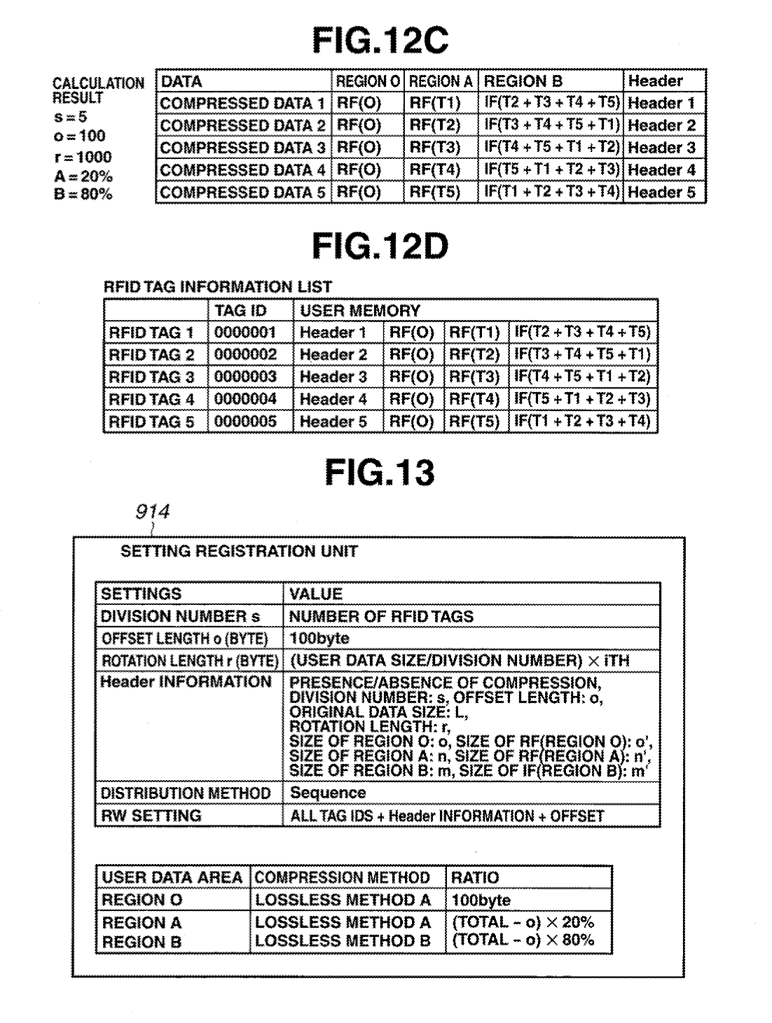

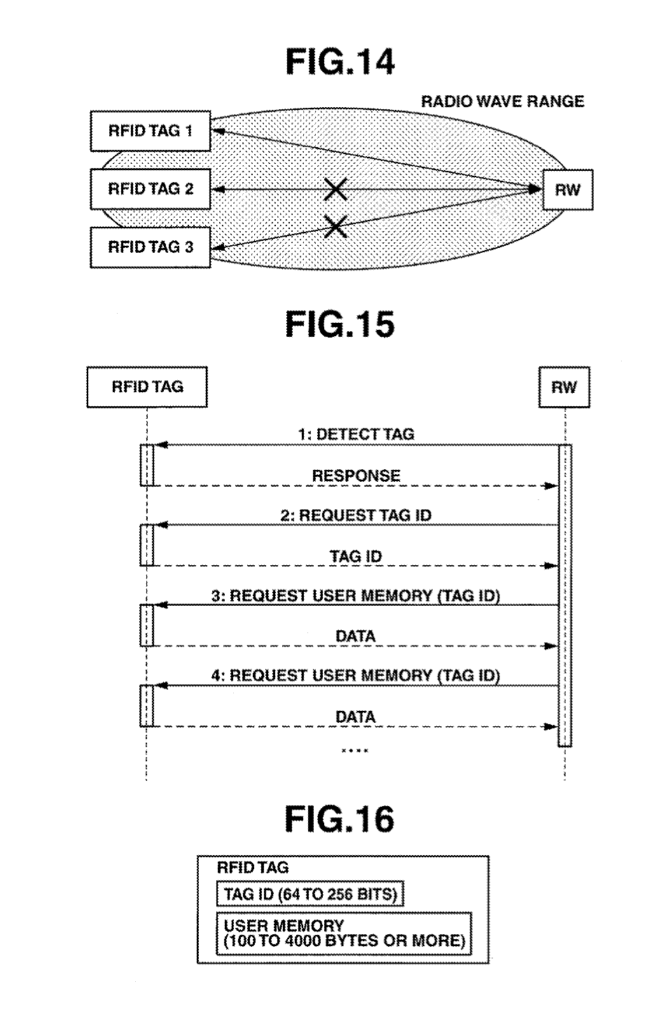

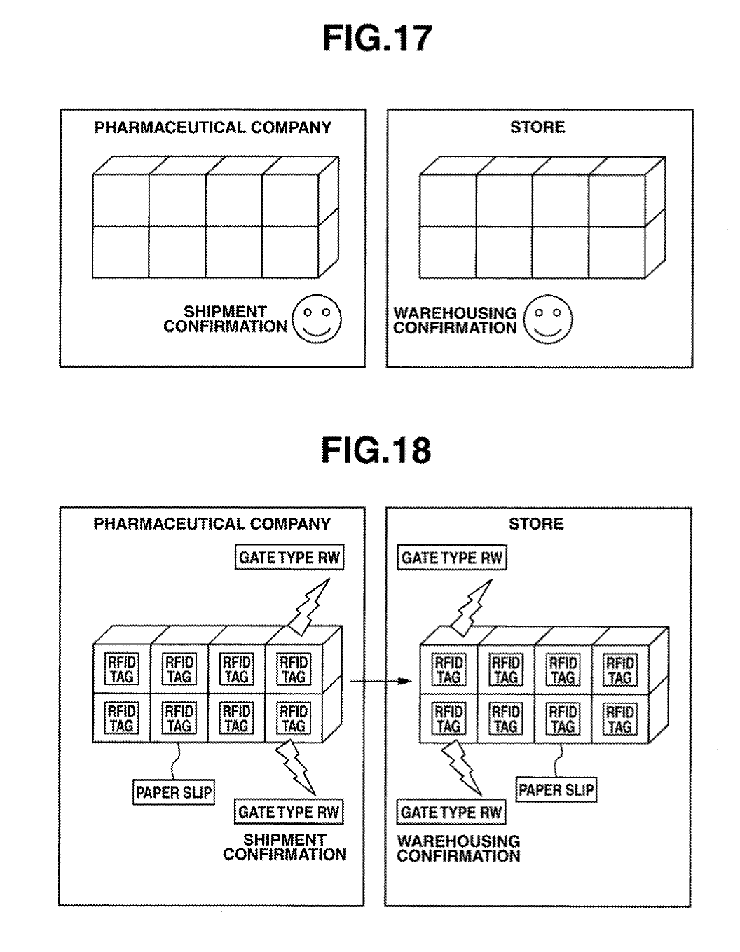

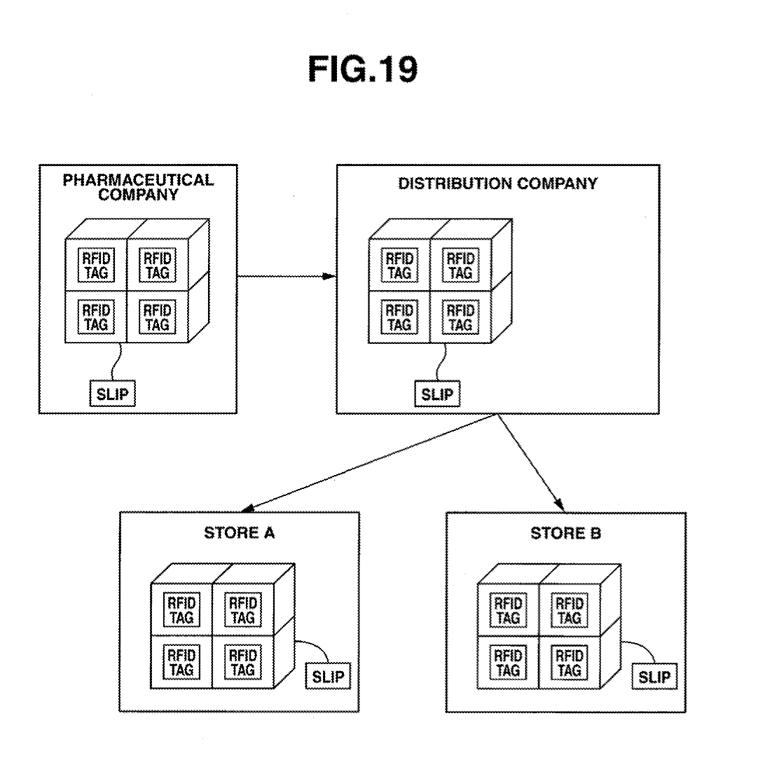

FIG. 7C is a view showing the structure of tag storage user data 404;

FIG. 8 is a view showing another structure of setting information held by the setting registration unit 111;

FIG. 9 is a block diagram showing the arrangement of a system according to Example 1;

FIG. 10A is a view showing the structure of the tag IDs of RFID tags 904 according to Example 1;

FIG. 10B is a view showing the structure of user data 920;

FIG. 10C is a view showing the structure of divided/compressed data according to Example 1;

FIG. 10D is a view showing an example of the structure of an RFID tag information list according to Example 1;

FIG. 11 is a view showing a structure of setting information held by a setting registration unit 914;

FIG. 12A is a view showing the structure of user data 930;

FIG. 12B is a view showing the structure of the tag IDs of RFID tags 904 according to Example 2;

FIG. 12C a view showing the structure of divided/compressed data according to Example 2;

FIG. 12D is a view showing an example of the structure of an RFID tag information list according to Example 2;

FIG. 13 is a view showing another structure of setting information held by the setting registration unit 914;

FIG. 14 is a view showing an example of the arrangement of a system using RFID tags;

FIG. 15 is a view for explaining communication between an RFID tag and an RW;

FIG. 16 is a view showing the structure of an RFID tag;

FIG. 17 is a view for explaining article shipment/warehousing between a pharmaceutical company and a store;

FIG. 18 is a view for explaining an arrangement which manages article shipment/warehousing between a pharmaceutical company and a store using RFID tags; and

FIG. 19 is a view for explaining an arrangement which manages article shipment/warehousing among a pharmaceutical company, a distribution company, and a store using RFID tags.

### BEST MODE FOR CARRYING OUT THE INVENTION

The exemplary embodiments of the present invention will now be described with reference to the accompanying drawings.

### First Exemplary Embodiment

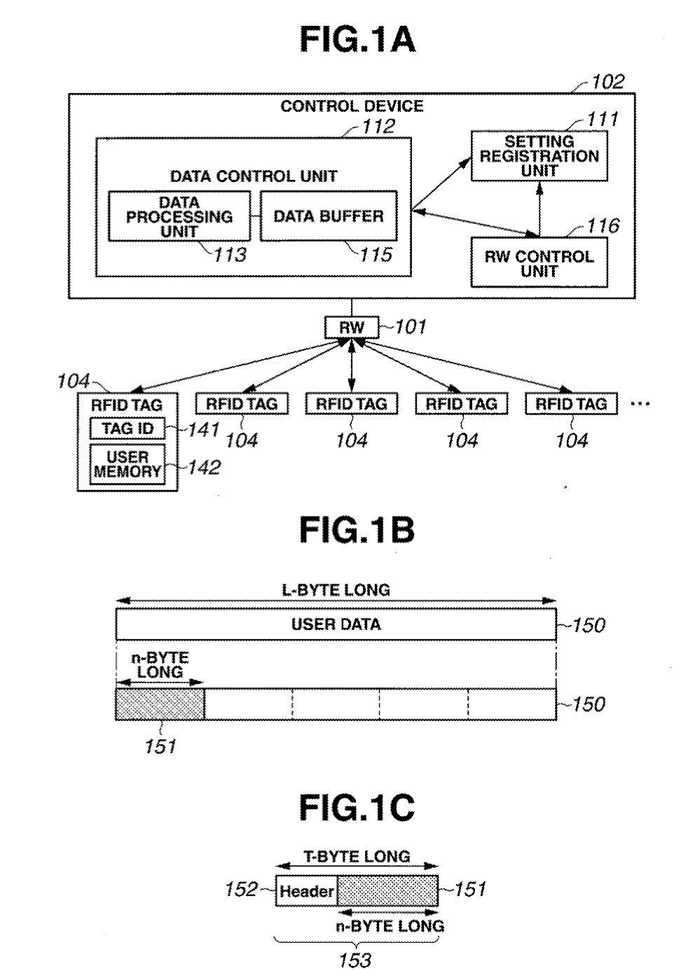

The first exemplary embodiment of the present invention will be described first. FIG. 1A is a block diagram showing the arrangement of a system for implementing an IC tag control method according to the first exemplary embodiment of the present invention. This system includes a reader/writer (RW) 101, a control device 102, and a plurality of RFID tags 104. Each RFID tag 104 includes a tag ID storage unit 141 which stores a tag ID, and a user memory 142 which stores user data. The RW 101 communicates with the RFID tags 104 using a radio wave so as to read/write the tag IDs and user data from/in the RFID tags 104.

The control device 102 includes a setting registration unit 111, a data control unit 112, and a reader/writer (RW) control unit 116. The setting registration unit 111 stores settings to be used by the data control unit 112 and the RW control unit 116. The user can change the settings. The data control unit 112 includes a data processing unit 113 and a data buffer 115. The data processing unit 113 divides user data to be stored in the user memory 142 of the RFID tag 104. The data processing unit 113 performs, on the data buffer 115, an operation such as the above-described data division.

The RW control unit 116 controls the RW 101 to read out the tag ID stored in the tag ID storage unit 141 of the RFID tag 104 or read/write-access user data (divided user data) stored in the user memory 142 of the RFID tag 104.

An example of the operation of the system (an example of the IC tag control method) according to the exemplary embodiment will be described next. An example in which five RFID tags 104 are used will be explained below. First, the control device 102 receives information (tag ID) and user data of each RFID tag 104 necessary for, for example, article management using the RFID tags 104. The data control unit 112 reads out setting information from the setting registration unit ill, acquires a division number s and user area information from the received information and user data, and performs necessary calculation. After that, the data control unit 112 transfers the received user data to the data processing unit 113.

As shown in FIG. 1B, the data processing unit 113 divides received L-byte user data 150 by the division number s into n-byte divided user data 151 and stores them in the data buffer 115. Next, the data processing unit 113 generates Header information concerning the divided user data 151 and stores them in the data buffer 115. The Header information includes the information of the divided user data such as the division number s.

As shown in FIG. 1C, the data processing unit 113 then puts the divided user data 151 and the generated Header information 152 together to generate tag storage user data 153. The data control unit 112 creates different tag storage user data 153 equal in number to the division number s.

The data processing unit 113 creates a write RFID tag information list which associates the tag ID stored in the tag ID storage unit 141 of each RFID tag 104 with the created tag storage user data 153, and notifies the RW control unit 116 of it.

Upon receiving the write RFID tag information list, the RW control unit 116 detects the RFID tag 104 whose tag ID storage unit 141 stores a tag ID in the list, and writes (stores) the tag storage user data 153 associated with the tag ID in the user memory 142 of the detected RFID tag 104. The RW control unit 116 controls the RW 101 to transmit all divided data to the RFID tags 104 having corresponding tag IDs based on the write RFID tag information list, thereby performing the above-described write. In this example, the user data 150 is divided into five divided user data 151. Hence, the five tag storage user data 153 are stored in the five RFID tags 104, respectively.

To reconstruct the divided data, the RW 101 first detects each RFID tag 104, and using the method set in the setting registration unit 111, acquires (receives) the tag storage user data 153 (divided user data 151 Header information 152) stored in the user memory 142 of each RFID tag 104 together with the tag ID stored in the tag ID storage unit 141.

The RW control unit 116 creates, based on the acquired tag IDs and tag storage user data 153, a read RFID tag information list which associates the tag IDs, divided user data 151, and Header information 152 with each other, and notifies the data control unit 112 of it.

Using the setting information set in the setting registration unit 111 and the Header information in the received read RFID tag information list, the data control unit 112 reconstructs the user data 150 from the acquired (received) divided user data 151.

First, the data processing unit 113 separates the tag storage user data 153 read out from the user memory 142 of each RFID tag 104 into the Header information 152 and the divided user data 151 using the setting information in the setting registration unit 111. The data buffer 115 stores each separated data. The data processing unit 113 acquires the division number s and the like from the Header information that is one of the separated data. After that, the data processing unit 113 arranges the divided user data 151, each of which is the other separated data, in the original order based on, for example, the Header information obtained upon separation, thereby reconstructing the user data 150. In this example, the five divided user data 151 are put together to reconstruct the original user data 150. Using the thus reconstructed user data 150 and the read RFID tag information list allows to, for example, manage warehousing using the RFID tags 104.

As described above, according to this exemplary embodiment, the enormous quantity of user data 150 is distributively stored in the user memories 142 of the plurality of RFID tags 104. It is therefore possible to suppress the amount of data to be transmitted from the RW 101 to the RFID tag 104 at the time of write. To use the user data 150, the divided user data 151 distributed to the RFID tags 104 are extracted to reconstruct the user data 150. It is also possible to suppress the amount of data to be transmitted from the RFID tag 104 to the RW 101 upon reading out data from the RFID tag 104 as well.

According to this exemplary embodiment, since the amount of data to be transmitted/received between the RW 101 and the RFID tag 104 can be reduced, the decrease in the communication speed between them can be suppressed. In addition, since the amount of data to be transmitted/received can be reduced, errors in communication can also be suppressed, thus suppressing the decrease in the communication accuracy.

### Second Exemplary Embodiment

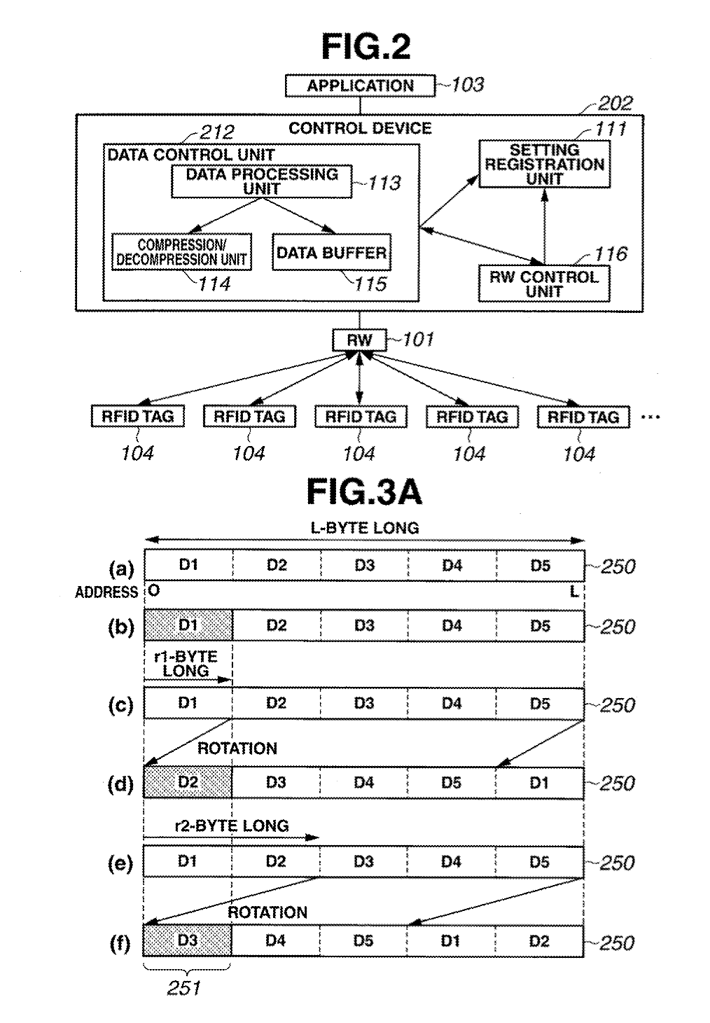

The second exemplary embodiment of the present invention will be described next. FIG. 2 is a block diagram showing the arrangement of a system for implementing an IC tag control method according to the second exemplary embodiment of the present invention. This system includes a reader/writer (RW) 101, a control device 202, an application 103, and a plurality of RFID tags 104. Each RFID tag 104 includes a tag ID storage unit 141 which stores a tag ID, and a user memory 142 which stores user data. The RW 101 communicates with the RFID tags 104 using a radio wave so as to read/write the tag IDs and user data from/in the RFID tags 104. The RFID tags 104 and the RW 101 are the same as in the above-described first exemplary embodiment.

The control device 202 controls the RW 101 and the RFID tags 104 to store or change, in the RFID tags 104, user data received from the application 103 to be described later. The control device 202 controls the RW 101 to control tag ID registration (storage) in the tag ID storage unit 141 of an arbitrary RFID tag 104 and control user data registration in the user memory 142. The control device 202 includes a setting registration unit 111, a data control unit 212, and an RW control unit 116.

The setting registration unit 111 stores setting information to be used by the data control unit 112 and the RW control unit 116. The user can change the settings. For example, as shown in FIG. 4, the setting registration unit 111 stores information to be used to divide and compress user data such as a division number s, rotation length r, Header information, distribution method, and RW settings and a compressed data reconstruction method. The user can change the set values to arbitrary values. A user data area designation method is also registered in the setting registration unit 111. An arbitrary division number can be designated for the user data area dividing method.

The data control unit 212 includes a data processing unit 113, a compression/decompression unit (compression means and decompression means) 114, and a data buffer 115. The data control unit 212 divides user data to be stored in the user memory 142 of the RFID tag 104 and compresses/decompresses the divided data.

The RW control unit 116 can control the RW 101 to control read of the tag ID stored in the tag ID storage unit 141 of the RFID tag 104 or read/write of user data (divided user data) stored in the user memory 142 of the RFID tag 104.

The application 103 is the main system for implementing, for example, ERP (Enterprise Resource Planning) to be used by the user, and confirms the data and contents of an order slip and order contents. The application 103 serves as a system for managing articles and warehousing/retrieval using the tag IDs and user data of the RFID tags 104. In this exemplary embodiment, the application 103 generates information of an RFID tag and arbitrary user data based on order information.

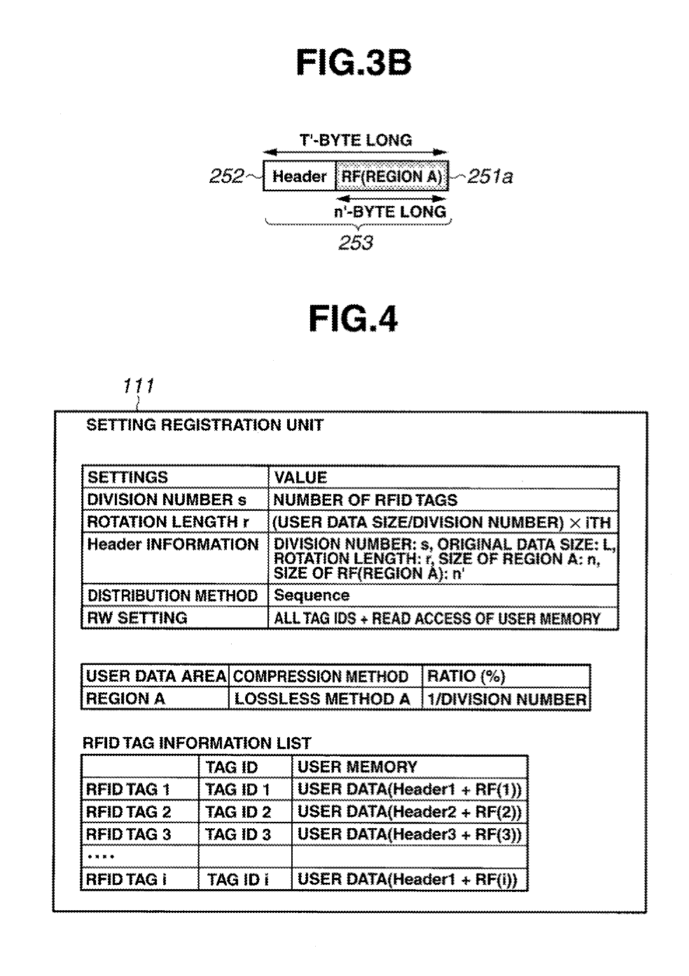

An example of the operation of the system will be described next with reference to FIGS. 2, 3A, 3B, and 4. FIGS. 3A and 3B show a state in which user data 250 is divided and compressed. FIG. 3A illustrates user data to be divided into five pieces. FIG. 4 shows setting information held in the setting registration unit 111. The setting registration unit 111 stores the division number s, rotation length r, Header information, user data area information, and the like.

First, upon receiving order information or the like, the application 103 generates RFID tag information (tag ID) based on the order information. The application 103 calculates the necessary number of RFID tags based on the order information, and generates RFID tag information in the necessary number. Assume that I pieces of RFID tag information are generated. The application 103 also generates the user data 250 as shown in (a) of FIG. 3A. The user data 250 is a large quantity of L-byte data that is a set of data necessary for the system using the above-described application 103 to operate.

After that, the application 103 sends the I pieces of RFID tag information and the user data 250 to the control device 202 to associate them with each other.

Upon receiving the I pieces of RFID tag information and the user data 250 from the application 103, the control device 202 divides the user data 250 into a predetermined number of pieces, compresses the divided data, and stores them in the user memories 142 of the plurality of RFID tags 104. This associates the user data 250 with the I RFID tags.

First, the data control unit 212 reads out setting information from the setting registration unit 111, acquires the division number s, rotation length r, and user area information from the RFID tag information and the information of the user data 250 received from the application 103, performs necessary calculation, and transfers the data to the data processing unit 113. In this example, the division number s equals the necessary number I of RFID tags 104.

The data processing unit 113 divides and compresses the user data 250. When dividing, the user data 250 is first rotated by the obtained rotation length r and divided into n-byte long regions A. In this division, as indicated by (b) of FIG. 3A, first D1 of the five divided data is extracted from the user data 250. Next, as indicated by (c) and (d) of FIG. 3A, the user data 250 is rotated by a rotation length r1 to place D2 at the top, and D2 placed at the top is extracted. The rotation length r1 corresponds to one divided region.

Next, as indicated by (e) and (f) of FIG. 3A, the user data 250 is rotated by a rotation length r2 to place D3 at the top, and D3 placed at the top is extracted. The rotation length r2 corresponds to two divided regions. This procedure is successively repeated to create five (s) divided user data 251. The data buffer 115 stores the created divided user data 251.

The compression/decompression unit 114 in the data control unit 212 compresses each of the s divided user data 251 by the compression method set in the setting registration unit 111. In this example, each data is compressed by lossless method A so as to generate ReversibleFunction( ). Note that compressed data generated by compression complying with lossless method A will be referred to as RF( ) hereinafter. For example, when region A corresponding to the whole divided user data 251 is compressed by lossless method A, compressed data RF(region A) is generated. Note that the size of RF (divided user data 251) obtained by compressing the n-byte divided user data 251 by lossless method A is n′ bytes. The data buffer 115 stores the obtained compressed data.

The data processing unit 113 then generates Header information concerning the compressed data. The Header information includes information such as the division number s, original data size L, rotation length r, size n of region A, and size n′ of RF( ), which are necessary for reconstructing the divided compressed data. The data buffer 115 stores the generated Header information.

When the compressed data and Header information are thus obtained, tag storage user data 253 including divided compressed data 251a corresponding to the compressed data RF(region A) and Header information 252 is created, as shown in FIG. 3B. As described above, the divided user data 251 is divided by the division number s to create the s divided user data 251. Hence, the data control unit 212 creates different tag storage user data 253 equal in number to the division number s.

The data processing unit 113 repeats I times associating (assigning) one tag storage user data 253 with (to) one RFID tag 104. A write RFID tag information list which associates the s tag storage user data 253 with the I RFID tags 104, respectively, is thus created. The data processing unit 113 notifies the RW control unit 116 of the created write RFID tag information list.

The RW control unit 116 detects the RFID tag 104 whose tag ID storage unit 141 stores a tag ID in the write RFID tag information list, and writes (stores) the tag storage user data 253 associated with the tag ID in the user memory 142 of the detected RFID tag 104. The RW control unit 116 controls the RW 101 to perform this write.

Since the plurality of (s) tag storage user data 253 are generated, they can distributively be stored in the user memories 142 of the plurality of (I) RFID tags 104. This allows to creates divided compressed data from the large quantity of user data 250 and distributively store them in the I RFID tags 104.

To reconstruct the divided compressed data, the RW 101 first detects each RFID tag, and using the method set in the setting registration unit 111, acquires data stored in the user memory 142 of each RFID tag 104.

The RW control unit 116 creates, based on the acquired tag IDs and tag storage user data 253, a read RFID tag information list which associates the tag IDs, divided compressed data 251a, and Header information 252 with each other, and notifies the data control unit 212 of it.

Using the setting registration unit 111 and the Header information in the read RFID tag information list, the data control unit 212 reconstructs the divided user data 251 from the acquired divided compressed data 251a.

The data control unit 212 transfers the tag storage user data 253 of (stored in) one RFID tag 104 in the read RFID tag information list and the information in the setting registration unit 111 to the data processing unit 113, thereby starting reconstruction processing.

The data processing unit 113 separates the tag storage user data 253 into the Header information 252 and the divided compressed data 251a using the information in the setting registration unit 111. The data buffer 115 stores each separated data. The data processing unit 113 acquires the division number s, original data size L, rotation length r, size n of region A (divided user data 251), and size n′ of divided compressed data 251a from the Header information 252 that is one of the separated data.

The compression/decompression unit 114 decompresses the divided compressed data 251a that is the other separated data by a designated method. With this decompression, the divided user data 251 is reconstructed. The data buffer 115 stores the reconstructed divided user data 251. Reconstruction of the user memory 142 of one RFID tag 104 thus ends. This data reconstruction operation is repeated as many number of times as the RFID tags in the read RFID tag information list.

In this case, the divided user data 251 can completely be reconstructed. However, since this is merely one of the divided parts of the original user data 250, the original user data 250 cannot be reconstructed from the user memory 142 of one RFID tag 104. In this exemplary embodiment, the divided user data 251 obtained by dividing the user data 250 are distributively stored in the RFID tags 104. Hence, the original user data 250 can completely be reconstructed by analyzing all divided user data 251 in the read RFID tag information list and preparing the divided user data 251 equal in number to the division number s.

After the user data 250 is reconstructed by analyzing the whole read RFID tag information list, the user data 250 and the information of the read RFID tag information list are sent to the application 103. The application 103 can then use the list of RFID tags 104 and the large quantity of arbitrary data associated with them.

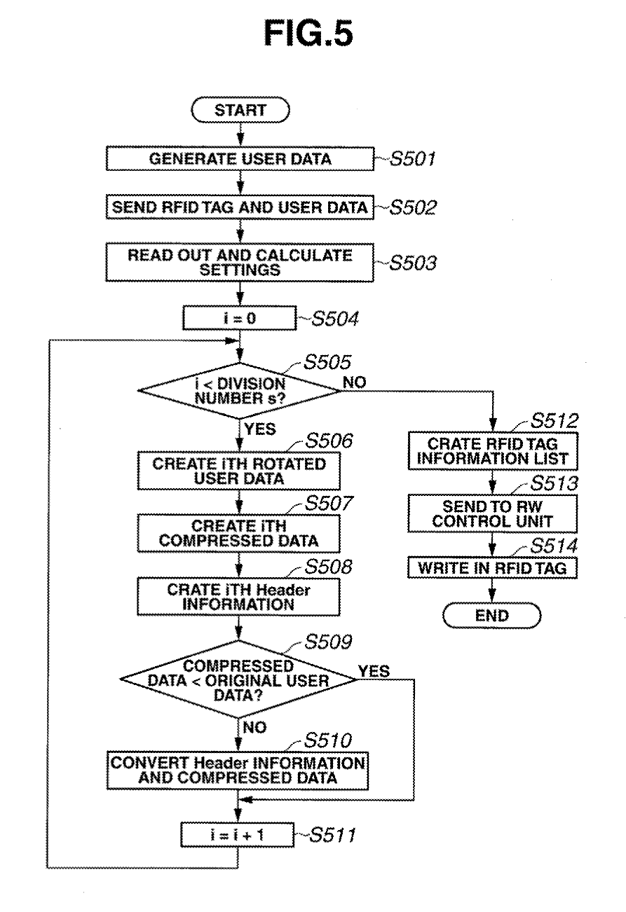

An operation example will be described next in more detail with reference to the flowchart of FIG. 5. Note that the setting information as shown in FIG. 4 is already registered in the setting registration unit 111 of the control device 202.

First, the application 103 receives order information or the like and generates RFID tag information and the user data 250 concerning the received order information (step S501). To associate the RFID tag information (tag IDs) with the user data 250, the application 103 sends the information of the tag IDs and the user data 250 to the control device 202 (step S502).

The data control unit 212 of the control device 202 reads out the settings from the setting registration unit 111 and then reads out the division number s, rotation length r, and Header information. The data control unit 212 calculates the division number s and the rotation length r from the readout setting information and the RFID tag information (step S503).

In step S504, a count i is set to 0. Upon determining in step S505 that the number of compressed data generated from the user data 250 equals the designated division number s, the process advances to step S512. Otherwise, the process advances to step S506.

In step S506, the data control unit 212 transfers the calculated division number s, rotation length r, user data area information, Header information, user data, and the like to the data processing unit 113. The data processing unit 113 creates the ith divided user data 251. The data processing unit 113 creates the divided user data 251 by moving the data of the rotation portion by the rotation length r and extracting it, as described above. In this exemplary embodiment, the rotation length r is obtained by calculation and changes for every ith data. The data buffer 115 stores the created divided user data 251.

In step S507, the data processing unit 113 compresses the ith divided user data 251 using the compression/decompression unit 114. The data processing unit 113 compresses each divided user data 251 corresponding to region A using the compression/decompression unit 114 by a designated method. In this example, all the divided user data 251 correspond to region A. The divided compressed data 251a is thus generated by compressing the divided user data 251. The data buffer 115 stores the created ith divided compressed data 251a.

In step S508, the data processing unit 113 creates the ith Header information 252. The Header information includes data (division number s, original data size L, rotation length r, size n of region A, and size n′ of RF(region A)) necessary for reconstructing the compressed data. After that, the tag storage user data 253 is created by putting the created Header information 252 and the divided compressed data 251a together and stored in the data buffer 115.

In step S509, the data size of the divided compressed data 251a of the tag storage user data 253 is compared with that of the divided user data 251 before compression. If the divided compressed data 251a is larger than the divided user data 251, the process advances to step S510 to change the Header information 252 to “uncompressed” and discard the created tag storage user data 253. Then, new tag storage user data 253 is created using the original divided user data 251 and the Header information 252 “uncompressed” and stored in the data buffer 115.

On the other hand, if the tag storage user data 253 is smaller than the divided user data 251, compressed data generation is successful, and the process advances to step S511. In step S511, i is incremented by one to create the next tag storage user data 253, and the process returns to step S505.

Steps S505 to S511 described above are repeated until i equals the division number s, thereby generating the tag storage user data 253 equal in number to the, division number s.

When the s tag storage user data 253 are generated (NO in step S505), the process advances to step S512 to create the write RFID tag information list. The write RFID tag information list includes combinations of the tag IDs and the tag storage user data 253. The data control unit 212 reads out the distribution method set in the setting registration unit 111 and combines the s tag storage user data 253 so as to distributively store them in the user memories of the I RFID tags, thus creating the write RFID tag information list (step S512).

In step S513, the data control unit 212 notifies the RW control unit 116 of the generated write RFID tag information list.

The RW control unit 116 detects each RFID tag 104 based on the information of the received write RFID tag information list, and writes the tag storage user data 253 in the user memory 142 of the RFID tag 104 having a designated tag ID (step S514). The s tag storage user data 253 are distributively stored in the I RFID tags, and the processing ends.

The above-described processing makes it possible to create s divided compressed data (tag storage user data 253) from one user data 250 and distributively store them in the user memories 142 of the I RFID tags 104.

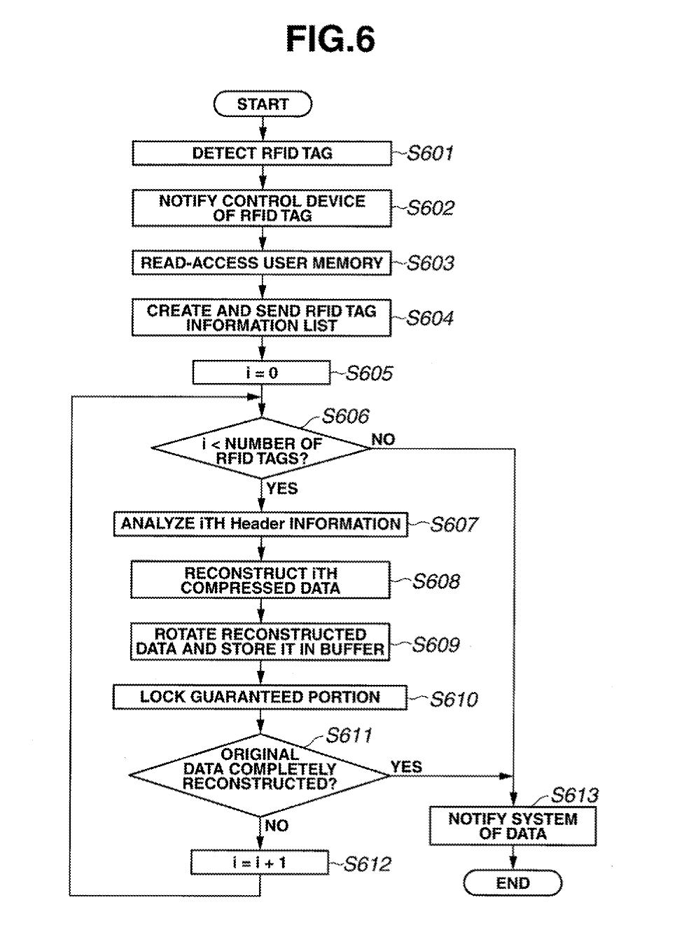

The procedure of an operation of reconstructing divided compressed data will be described next with reference to the flowchart of FIG. 6.

When the RFID tag 104 enters the radio wave range of the RW 101, the RW 101 detects the RFTD tag 104 (step S601). Upon detecting the RFID tag 104, the RW 101 reads out the tag ID from the tag ID storage unit 141 of the detected RFID tag 104 and notifies the control device 202 of the readout tag ID (step S602).

The RW control unit 116 instructs the RW 101 to read out data (tag storage user data 253) stored in the user memory 142 of the RFID tag 104 by a read method set in the setting registration unit 111 using the detected tag ID (step S603). The tag storage user data 253 stored in the user memory 142 of the detected RFID tag 104 is thus read out.

The RW control unit 116 puts the acquired tag ID and the readout tag storage user data 253 together to create the read RFID tag information list and notifies the data control unit 212 of it (step S604).

In step S605, the count i is initialized to 0. In step S606, it is confirmed whether the count i is smaller than the number of RFID tags 104 in the read RFID tag information list. If the count i is smaller than the number of RFID tags 104, the process advances to step S607. Otherwise, the user memories of all RFID tags 104 have been analyzed, and the process advances to step S613 to end the processing.

In step S607, the data control unit 212 starts analyzing the read RFID tag information list. When analyzing the read RFID tag information list, the information of the tag storage user data 253 is analyzed for each RFID tag 104.

In step S608, the data control unit 212 reconstructs the tag storage user data 253 using the read RFID tag information list. The data processing unit 113 separates the tag storage user data 253 into the Header information 252 and the divided compressed data 251a using the information in the setting registration unit 111. The data buffer 115 stores each separated data.

The data processing unit 113 acquires the division number s, original data size L, rotation length r, size n of region A (divided user data 251), and size n′ of divided compressed data 251a from the Header information 252. At this time, if i=0, the data processing unit 113 creates a user data buffer of data size L in the data buffer 115. The user data buffer serves as an area to store reconstructed data.

The data processing unit 113 reconstructs the divided compressed data 251a using the analyzed Header information 252. The divided compressed data 251a is compressed by lossless method A. Hence, the data processing unit 113 extracts the divided compressed data 251a from the data buffer 115 and reconstructs the divided compressed data 251a by lossless method A using the compression/decompression unit 114, thereby creating the divided user data 251. The divided compressed data 251a can thus be reconstructed to the complete divided user data 251 (step S608).

In step S609, the data processing unit 113 returns the reconstructed divided user data 251 to the arranged state in the original user data 250 using the rotation length r and stores it in the user data buffer created in the data buffer 115.

For a portion of the reconstructed data in the user data buffer where data completeness can be guaranteed, the data processing unit 113 locks the stored data (step S610). Hence, no data can be written in the completely reconstructed and locked portion in step S609.

In step S611, the data processing unit 113 checks the contents of the user data buffer and confirms whether the original data (user data 250) is completely reconstructed. When the original user data 250 is completely reconstructed, the process advances to step S613. If the data is not reconstructed, the process advances to step S612 to increment i by one to analyze the information (tag storage user data 253) of the next RFID tag 104. Then, the process returns to step S606.

Steps S606 to S612 described above are repeated, thereby reconstructing the original user data 250. When the original data is completely reconstructed, or the pieces of information of all RFID tags 104 are analyzed, the control device notifies the system of the information of the original user data and the RFID tags 104 obtained by analysis (step S613).

As described above, the user data of the I RFID tags 104 are read out, the divided compressed data 251a obtained by compressing s different portions are acquired, and analysis and decompression are performed, thereby obtaining the complete user data 250.

### Third Exemplary Embodiment

The third exemplary embodiment of the present invention will be described next. In the above-described second exemplary embodiment, the user data 250 is divided into the divided user data 251. One divided user data 251 is compressed by a lossless method, and the obtained divided compressed data 251a is stored in the user memory 142 of each RFID tag 104. However, the present invention is not limited to this. In the third exemplary embodiment, a case will be described below in which a plurality of regions generated by division are compressed by different compression methods and stored in user memories 142. Note that the same system as in the second exemplary embodiment described with reference to FIG. 2 is used in the third exemplary embodiment as well.

First, an application 103 receives order information or the like. The application 103 generates RFID tag information and L-byte user data 400, as shown in FIG. 7A, based on the order information. The application 103 sends I pieces of RFID tag information and the user data 400 to a control device 202 to associate them with each other.

Upon receiving the I pieces of RFID tag information and the user data 400 from the application 103, the control device 202 distributively (divisionally) compresses and stores the user data 400 in the user memories of the plurality of RFID tags, thereby associating the user data 250 with the I RFID tags.

When associating, a data control unit 212 reads out setting information from a setting registration unit 111 and acquires, by calculation, a division number s, offset length o, rotation length r, and information of regions A and B from the RFID tag information and the information of the user data 400 received from the application 103.

A data processing unit 113 then divides and compresses the user data 400 using the calculated values.

First, using the offset length o, the data processing unit 113 creates user data by dividing the user data 400 into an offset and a rotation portion, as shown in FIG. 7B. Next, the rotation portion is rotated by the calculated rotation length r and divided into two parts, that is, n-byte region A divided data 401 and m-byte region B divided data 402.

For example, when the division number is five, the user data 400 is divided into an offset based on the set offset length o and a rotation portion, as indicated by (a) of FIG. 7B. The rotation portion is further divided into D1, D2, D3, D4, and D5. Next, as indicated by (b) of FIG. 7B, the offset portion and D1 that is the first r-byte portion from the start of the rotation portion are combined to generate the region A divided data 401. The remaining portion corresponding to D2, D3, D4, and D5 is defined as the region B divided data 402.

The rotation portion is rotated by a rotation length 1r. With this processing, the rotation portion includes data in the order of D2, D3, D4, D5, and D1, as indicated by (c) of FIG. 7B. When the first r-byte portion from the start of the rotation portion is extracted in this state, D2 is extracted. D2 thus extracted and the offset portion are combined to generate the next region A divided data 401. The remaining portion corresponding to D3, D4, D5, and D1 is defined as the next region B divided data 402.

The rotation portion is rotated by a rotation length 2r. With this processing, the rotation portion includes data in the order of D3, D4, D5, D1, and D2, as indicated by (d) of FIG. 7B. When the first r-byte portion from the start of the rotation portion is extracted in this state, D3 is extracted. D3 thus extracted and the offset portion are combined to generate the next region A divided data 401. The remaining portion corresponding to D4, D5, D1, and D2 is defined as the next region B divided data 402.

The rotation portion is rotated by a rotation length 3r. With this processing, the rotation portion includes data in the order of D4, D5, D1, D2, and D3, as indicated by (e) of FIG. 7B. When the first r-byte portion from the start of the rotation portion is extracted in this state, D4 is extracted. 15. D4 thus extracted and the offset portion are combined to generate the next region A divided data 401. The remaining portion corresponding to D5, D1, D2, and D3 is defined as the next region B divided data 402.

Finally, the rotation portion is rotated by a rotation length 4r. With this processing, the rotation portion includes data in the order of D5, D1, D2, D3, and D4, as indicated by (f) of FIG. 7B. When the first r-byte portion from the start of the rotation portion is extracted in this state, D5 is extracted. D5 thus extracted and the offset portion are combined to generate the next region A divided data 401. The remaining portion corresponding to D1, D2, D3, and D4 is defined as the next region B divided data 402.

With the above-described processing, five kinds of sets of region A divided data 401 and region B divided data 402 are created. All regions A include the common offset portion. The original user data 400 is completely reconstructed by the region A divided data 401 and the region B divided data 402 of a single set. In this case, though a plurality of sets of region A divided data 401 and region B divided data 402 are created, the original user data 400 can be reconstructed by any one set of region A divided data 401 and region B divided data 402.

In the above-described division, unless the offset length o is 0, the offset portion is not rotated, and only the rotation portion is rotated to change the portion to be extracted for the division. This guarantees that the offset portion is always included in the region A divided data 401 and stored in the user memories 142 of all RFID tags 104. Note that when the offset length o is 0 byte, the entire user data 400 is used as the rotation portion, and data address 0 (the top of the data) is rotated by the rotation length r.

A data buffer 115 stores the region A divided data 401 and the region B divided data 402 thus created by the division.

The user can change set values set in the setting information to arbitrary values. The user data area designation method is also registered in the setting registration unit 111. An arbitrary division number can be designated for the user data area dividing method so as to divide data into, for example, region A and region B, as described above. For example, data may be divided into three regions, that is, region A, region B, and region C. As for compression to be described later, different compression methods may be applied to the respective regions.

Then, the data processing unit 113 compresses the region A divided data 401 and the region B divided data 402 using a compression/decompression unit 114 by the compression method set in the setting registration unit 111. In this exemplary embodiment, the region A divided data 401 is compressed by lossless method A to generate RF(region A). The size of RF(region A) is n′ bytes.

On the other hand, the region B divided data 402 is compressed by lossy method B so as to generate IrreversibleFunction(region B) (to be referred to as IF( ) hereinafter). The size of IF(region B) is m′ bytes. The data buffer 115 stores the generated compressed data RF(region A) and IF(region B).

Lossy compression is normally done at a higher compression rate than lossless compression, and the data size often decreases to 1/10 or less. Hence, even when the data amount of the region B divided data 402 is large, it can be decreased by the above-described compression. However, as a characteristic feature of the lossy compression, the original data cannot completely be reconstructed. In this exemplary embodiment, n′<n, and m′<<m.

The data processing unit 113 then generates Header information concerning the compressed data RF(region A) and IF(region B). The Header information includes information of the divided compressed data such as the division number s, offset length o, original data size L, rotation length r, size n of region A, size m of region B, size n′ of RF( ), and size m′ of IF( ). The data buffer 115 stores the generated Header information.

Next, as shown in FIG. 7C, Header information 403, divided compressed data RF(region A) 401a, and divided compressed data IF(region B) 402a are put together to create tag storage user data 404. The data control unit 212 creates different tag storage user data 404 equal in number to the division number s.

The data processing unit 113 repeats I times assigning one tag storage user data 404 to one corresponding RFID tag 104, thereby creating a write RFID tag information list which includes I pieces of information in which the tag storage user data 404 are assigned to the RFID tags 104. The data processing unit 113 notifies an RW control unit 116 of the created write RFID tag information list.

The RW control unit 116 detects a tag ID in the write RFID tag information list, and writes the designated tag storage user data 404 in the user memory 142 of the corresponding RFID tag 104. Since the plurality of (s) tag storage user data 404 are created, they are distributively stored in the user memories 142 of the plurality of RFID tags 104.

This allows to create s divided compressed tag storage user data 404 from the large quantity of user data 400 and distributively store them in the I RFID tags. Note that though s equals I in this exemplary embodiment, as described above, the numbers may be different.

Data reconstruction will be described next. Data reconstruction starts with the RW 101 detecting the RFID tag 104. Upon detecting the RFID tag 104, the RW 101 acquires, using the set method, data in the user memory 142 of the detected RFID tag 104. The acquired data includes the tag storage user data 404. Upon detecting, the tag ID stored in a tag ID storage unit 141 of the RFID tag 104 is also acquired. (0130] The RW control unit 116 creates a read RFID tag information list based on the tag IDs and data (tag storage user data 404) in the user memories thus acquired by the RW 101, and notifies the data control unit 212 of it. Using the setting registration unit 111 and the Header information in the read RFID tag information list, the data control unit 212 reconstructs the region A divided data 401 and the region B divided data 402 from the tag storage user data 404.

The data control unit 212 transfers the tag storage user data 404 of one RFID tag (tag ID) in the read RFID tag information list and the information in the setting registration unit 111 to the data processing unit 113, thereby starting reconstruction processing.

The data processing unit 113 separates the tag storage user data 404 into the Header information 403, divided compressed data RF(region A) 401a , and divided compressed data IF(region B) 402a using the information in the setting registration unit 111. The data buffer 115 stores each separated data. The data processing unit 113 acquires the division number s, offset length o, original data size L, rotation length r, size n of region A, size m of region B, size n′ of RF(n), and size m′ of IF(m) from the Header information 403.

The compression/decompression unit 114 decompresses the separated divided compressed data RF(region A) 401a and divided compressed data IF(region B) 402a by a designated method. With this processing, the region A divided data 401 and the incomplete region B divided data 402 are reconstructed. The data buffer 115 stores these data.

With the above-described operation, reconstruction of the tag storage user data 404 stored in the user memory 142 of one RFID tag 104 ends. This data reconstruction operation is repeated as many number of times as the tag IDs registered in the read RFID tag information list.

In the above-described reconstruction, the region A divided data 401 can completely be reconstructed. However, since the divided compressed data IF(region B) 402a is incomplete data, the original user data 400 cannot completely be reconstructed from one tag storage user data 404.

In this exemplary embodiment, the user data 400 is divided to create the region A divided data 401 which is losslessly compressed. For this reason, when all tag storage user data 404 in the read RFID tag information list are analyzed and reconstructed (decompressed) to prepare the region A divided data 401 equal in number of the division number s, the original user data 400 can completely be reconstructed.

After the user data 400 is reconstructed by analyzing all tag storage user data 404, the reconstructed user data 400 and the information of the read RFID tag information list are sent to the application 103. This notification enables the application 103 to use the list of RFID tags 104 and arbitrary data associated with them. One RFID tag 104 includes the divided compressed data RF(region A) 401a and the divided compressed data IF(region B) 402a. Hence, the RFID tag includes the whole user data 400, though incomplete.

An operation example will be described next in more detail with reference to the flowchart of FIG. 5. Note that the setting information as shown in FIG. 8 is already registered in the setting registration unit 111 of the control device 202.

First, the application 103 receives order information or the like and generates RFID tags and the user data 400 concerning the received order information (step S501). To associate the RFID tags with the user data 400, the application 103 sends the information of the RFID tags and the user data 400 to the control device 202 (step S502).

The data control unit 212 of the control device 202 reads out the settings from the setting registration unit ill and then reads out the division number s, rotation length r, and Header information. The data control unit 212 calculates the division number s, rotation length r, and offset length from the readout setting information and the RFID tag information (step S503).

In step S504, a count i is set to 0. Upon determining in step S505 that the number of compressed data generated from the user data 400 equals the designated division number s, the process advances to step S512. Otherwise, the process advances to step S506.

In step S506, the data control unit 212 transfers the calculated division number s, offset length o, rotation length r, user data area information, Header information, user data, and the like to the data processing unit 113. The data processing unit 113 creates the ith region A divided data 401 and region B divided data 402, as described above. The data buffer 115 stores the created region A divided data 401 and region B divided data 402.

In step S507, the data processing unit 113 compresses the ith region A divided data 401 and region B divided data 402 using the compression/decompression unit 114. The compression/decompression unit 114 compresses each of the region A divided data 401 and region B divided data 402 by a designated method. With this processing, the divided compressed data RF(region A) 401a and the divided compressed data IF(region B) 402a are generated. The data buffer 115 stores these data.

In step S508, the data processing unit 113 creates the ith Header information 403. The Header information 403 includes data (division number s, original data size L, rotation length r, size n of region A, size m of region B, size n′ of RF(region A), and size m′ of IF(region B)) necessary for reconstructing the compressed data. After that, the tag storage user data 404 is created by putting the created Header information 403, divided compressed data RF(region A) 401a , and divided compressed data IF(region B) 402a together and stored in the data buffer 115.

In step S509, the total data size of the divided compressed data RF(region A) 401a and divided compressed data IF(region B) 402a of the tag storage user data 404 is compared with the data size of the original user data 400. If the total data size of the divided compressed data RF(region A) 401a and divided compressed data IF(region B) 402a is larger than the data size of the user data 400, the process advances to step S510 to change the Header information 403 to “uncompressed” and discard the created tag storage user data 404. Then, new tag storage user data 404 is created using the user data 400 and the Header information 403 “uncompressed” and stored in the data buffer 115.

On the other hand, if the total data size of the divided compressed data RF(region A) 401a and divided compressed data IF(region B) 402a is smaller than the data size of the user data 400, compressed data generation is successful, and the process advances to step S511. In step S511, i is incremented by one to create the next tag storage user data 404, and the process returns to step S505.

Steps S505 to S511 described above are repeated until i equals the division number s, thereby generating the tag storage user data 404 equal in number to the division number s.

When the s tag storage user data 404 are generated (NO in step S505), the process advances to step S512 to create the write RFID tag information list. The write RFID tag information list includes combinations of the tag IDs and the tag storage user data 404. The data control unit 212 reads out the distribution method set in the setting registration unit 111 and combines the s tag storage user data 404 so as to distributively store them in the user memories of the I RFID tags, thus creating the write RFID tag information list (step S512).

In step S513, the data control unit 212 notifies the RW control unit 116 of the generated write RFID tag information list.

The RW control unit 116 detects each RFID tag 104 based on the information of the received write RFID tag information list, and writes the corresponding tag storage user data 404 in the user memory 142 of the RFID tag 104 having a designated tag ID (step S514). The s tag storage user data 404 are distributively stored in the I RFID tags 104, and the processing ends.

The above-described processing makes it possible to create s divided compressed data (tag storage user data 404) from one user data 400 and distributively store them in the user memories 142 of the I RFID tags 104.

The procedure of an operation of reconstructing user data 400 from the plurality of tag storage user data 404 created by division and compression will be described next with reference to the flowchart of FIG. 6.

When the RFID tag enters the radio wave range of the RW 101, the RW 101 detects the RFID tag (step S601). Upon detecting the RFID tag 104, the RW 101 reads out the tag ID from the tag ID storage unit 141 of the detected RFID tag 104 and notifies the control device 202 of the readout tag ID (step S602).

The RW control unit 116 instructs the RW 101 to read out the tag storage user data 404 stored in the user memory 142 of the RFID tag 104 by a read method set in the setting registration unit 111 using the detected tag ID (step S603). The tag storage user data 404 stored in the user memory 142 of the detected RFID tag 104 is thus read out.

The RW control unit 116 puts the acquired tag ID, the readout tag storage user data 404, and the information of the user memory together to create the read RFID tag information list and notifies the data control unit 212 of it (step S604).

In step S605, the count i is initialized to 0. In step S606, it is confirmed whether the count i is smaller than the number of RFID tags 104 in the read RFID tag information list. If the count i is smaller than the number of RFID tags 104, the process advances to step S607. Otherwise, the user memories of all RFID tags 104 have been analyzed, and the process advances to step S613 to end the processing.

In step S607, the data control unit 212 starts analyzing the read RFID tag information list. When analyzing the read RFID tag information list, the information of the tag storage user data 404 is analyzed for each RFID tag 104.

In step S608, the data control unit 212 reconstructs the tag storage user data 404 using the read RFID tag information list. The data processing unit 113 separates the tag storage user data 404 into the Header information 403, divided compressed data RF(region A) 401a , and divided compressed data IF(region B) 402a using the information in the setting registration unit 111. The data buffer 115 stores each separated data.

The data processing unit 113 acquires the division number s, offset length o, original data size L, rotation length r, size n of region A, size m of region B, size n′ of RF(region A), and size m′ of IF(region B) from the Header information 403. At this time, if i=0, the data processing unit 113 creates a user data buffer of data size L in the data buffer 115. The user data buffer serves as an area to store reconstructed data.

The data processing unit 113 reconstructs the divided compressed data RF(region A) 401a and divided compressed data IF(region B) 402a using the analyzed Header information 403. The divided compressed data RF(region A) 401a is compressed by lossless method A. Hence, the data processing unit 1.1.3 extracts the divided compressed data RF(region A) 401a from the data buffer 115 and reconstructs the divided compressed data RF(region A) 401a by lossless method A using the compression/decompression unit 114.

On the other hand, the divided compressed data IF(region B) 402a is compressed by lossy method B. Hence, the data processing unit 113 extracts the divided compressed data IF(region B) 402a from the data buffer 115 and reconstructs the divided compressed data IF(region B) 402a by lossy method B using the compression/decompression unit 114.

With the above-described decompression operation, the divided compressed data RF(region A) 401a can be reconstructed to the complete region A divided data 401. On the other hand, the divided compressed data IF(region B) 402a is reconstructed to a state different from the original region B divided data 402 (step S608).

In step S609, the data processing unit 113 returns the reconstructed region A divided data 401 to the arrangement in the original user data 400 using the offset length o and the rotation length r. The rotation portion is calculated based on the offset length o. Each region A divided data 401 is reversely rotated by the rotation length r to be returned to the same data address as in the original user data 400. Next, the data processing unit 113 stores the reconstructed user data 400 in the user data buffer created in the data buffer 115.

For a portion of the reconstructed data in the user data buffer where data completeness can be guaranteed, the data processing unit 113 locks the stored data (step S610). Hence, no data can be written in the completely reconstructed and locked portion in step S609.

In step S611, the data processing unit 113 checks the contents of the user data buffer and confirms whether the original data is completely reconstructed. When the original user data 400 is completely reconstructed, the process advances to step S613. If the data is not reconstructed, the process advances to step S612 to increment i by one to analyze the next RFID tag information. Then, the process returns to step S606.

Steps S606 to S612 described above are repeated, thereby reconstructing the original user data 400. When the original data is completely reconstructed, or the pieces of information of all RFID tags 104 are analyzed, the control device notifies the system of the information of the original user data and the RFID tags 104 obtained by analysis (step S613).

As described above, the user data of the I RFID tags 104 are read out, the tag storage user data 404 obtained by compressing s different portions are acquired, and analysis and decompression are performed, thereby obtaining the complete user data 400. Additionally, in this exemplary embodiment, one RFID tag includes the whole user data 400, though incomplete.

Detailed examples will be described next.

### EXAMPLE 1

Example 1 will be described first. In Example 1, a case will be described in which, as shown in FIG. 9, a pharmaceutical company 901 receives order information from a store 902 and ships ordered medicaments 903, whereas the store 902 manages the received medicaments 903. All the medicaments 903 have RFID tags 904.

The pharmaceutical company 901 includes an RW 911 to be used to confirm shipment, a control device 912, and a pharmaceutical company system 916. The control device 912 includes a data control unit 913, a setting registration unit 914, and an RW control unit 915. On the other hand, the store 902 includes an RW 921 to be used to confirm warehousing, a control device 922, and a store system 926. The control device 922 includes a data control unit 923, a setting registration unit 924, and an RW control unit 925.

Note that the control devices 912 and 922 are the same as the control device 202 shown in FIG. 2. The data control units 913 and 923 correspond to the data control unit 212 in FIG. 2. The setting registration units 914 and 924 correspond to the setting registration unit 111 in FIG. 2. The RW control units 915 and 925 correspond to the RW control unit 116 in FIG. 2. The pharmaceutical company system 916 and the store system 926 correspond to the application 103 shown in FIG. 2.

First, the pharmaceutical company system 916 receives order information. In Example 1, assume that the store 902 gives an order for five medicaments 903. The pharmaceutical company 901 prepares the five medicaments 903 of the order and applies the RFID tag 904 to each medicament. The tag ID of each RFID tag 904 is tag ID information shown in FIG. 10A. The pharmaceutical company system 916 generates user data 920 based on the RFID tags 904 and the order information.

In Example 1, the user data 920 is 5000-byte slip image data, as shown in FIG. 10B. The pharmaceutical company system 916 needs to link the RFID tags 904 with the user data 920 to manage the medicaments 903. For this purpose, the pharmaceutical company system 916 notifies the control device 912 of the tag IDs of the RFID tags 904 and the user data 920.

The data control unit 913 of the control device 912 reads out setting information shown in, for example, FIG. 11 from the setting registration unit 914 and calculates the division number s and the rotation length r. In Example 1, the number of RFID tags is five. The data size of the user data 920 is 5,000 bytes. Set values set in the setting registration unit 914 are s=5 and r=1000 (and o=0).

Next, compressed data is created. Compressed data is created using data area information registered in the setting registration unit 914. In Example 1, region A uses lossless method A, and its ratio is 20%. Region B uses lossy method B, and its ratio is 80%. As a result of calculation, s=5, r=1000, A=20%, and B=80% are obtained.

The compressed data are generated equal in number to the'division number. In this example, five compressed data sets each including a region A portion and a region B portion are generated, as shown in FIG. 10C. For example, compressed data 1 of the first set includes RF(T1) obtained by losslessly compressing a portion T1 shown in FIG. 10B and IF(T2+T3+T4+T5) obtained by lossily compressing portions T2, T3, T4, and T5.

Header information corresponding to each compressed data set is created. The Header information includes the division number, rotation length, and original user data size and is used to reconstruct compressed data. In Example 1, for example, Header 1 that is Header information corresponding to compressed data 1 includes s=5, r=0, L=5000, n′=data size of RF(T1), and m′=data size of IF(T2+T3+T4+T5).

Compressed data 1 to 5 including Header 1 to 5 correspond to the above-described tag storage user data. Note that as described above, if comparison between compressed data and original data reveals that the compressed data is larger than the original data, the original data is used as the compressed data.

Next, to distributively store the created compressed data 1 to 5 in the RFID tags 904, a write RFID tag information list which sequentially associates compressed data 1 to 5 with the RFID tags 904 is created. In Example 1, to distributively store the compressed data in the RFID tags 904, a write RFID tag information list as shown in FIG. 10D is created.

The created write RFID tag information list is sent to the RW control unit 915. The RW control unit 915 detects the tag IDs in the write RFID tag information list and writes compressed data 1 to 5 in the corresponding RFID tags 904. In Example 1, five RFID tags 904 are used, and compressed data 1 to 5 are written in their user memories (not shown), respectively.

Data reconstruction in the store 902 which receives the medicaments 903 with the RFID tags 904 in which compressed data 1 to 5 have been written in the above-described way will be described next. First, when the medicaments 903 shipped by the pharmaceutical company 901 have arrived at the store 902, warehousing of the medicaments 903 is confirmed. When the medicaments 903 are warehoused, the RW 921 detects the RFID tag 904 within the radio wave range. Upon detecting an RFID tag, the RW 921 notifies the control device 922 of the tag ID of the detected RFID tag 904.

The RW control unit 925 of the control device 922 instructs the RW 921 to read-access the user memory of the RFID tag 904 using the received tag ID. In Example 1, the user memories of the five RFID tags 904 store compressed data 1 to 5. The RW 921 reads out these data and notifies the RW control unit 925 of them.

The RW control unit 925 puts the acquired tag IDs and readout compressed data 1 to 5 together to create a read RFID tag information list and notifies the data control unit 923 of it. In Example 1, the created read RFID tag information list is the same as the write RFID tag information list shown in FIG. 10D.

The data control unit 923 analyzes all compressed data in the write RFID tag information list and reconstructs them. The data control unit 923 acquires the division number s, rotation length r, size n′ of region A, size m′ of region B, and original data size L from Header 1 to 5 of compressed data 1 to 5. In Example 1, information of Header 1 includes s=5, r=0, n′32 n1, m′32 m1, and L=5000.

Compressed data 1 is reconstructed using the analyzed information of Header 1. In Example 1, compressed data RF(T1) of region A is reconstructed to T1 by lossless method A. Compressed data IF(T2+T3+T4+T5) of region B is reconstructed by lossy method B. However, since lossy method B cannot completely reconstruct original data, (T2+T3+T4+T5)′ is obtained.

The reconstructed data T1 and (T2+T3+T4+T5)′ are reversely rotated by the corresponding rotation lengths r to be returned to the same data addresses as in the original user data, and then stored in the data buffer. Note that as described above, for a portion of each reconstructed data where data completeness can be guaranteed, the data buffer is locked. Data completeness can be guaranteed in the portion compressed by lossless method A. Hence, the portion T1 in the data buffer is locked to prohibit overwrite. This also applies to the rest.

Compressed data 2 is reconstructed using the information of Header 2 to obtain the data T2 and (T3+T4+T5+T1)′. The data are reversely rotated by the corresponding rotation lengths r to be returned to the same data addresses as in the original user data, and then stored in the data buffer.

Compressed data 3 is reconstructed using the information of Header 3 to obtain the data T3 and (T4+T5+T1+T2)′. The data are reversely rotated by the corresponding rotation lengths r to be returned to the same data addresses as in the original user data, and then stored in the data buffer.

Compressed data 4 is reconstructed using the information of Header 4 to obtain the data T4 and (T5+T1+T2+T3)′. The data are reversely rotated by the corresponding rotation lengths r to be returned to the same data addresses as in the original user data, and then stored in the data buffer.

Finally, compressed data 5 is reconstructed using the information of Header 5 to obtain the data T5 and (T1+T2+T3+T4)′. The data are reversely rotated by the corresponding rotation lengths r to be returned to the same data addresses as in the original user data, and then stored in the data buffer.

With the above-described processing, the original user data 920 is reproduced in the data buffer. When the user data 920 is thus reconstructed, the control device notifies the store system 926 of the information of the user data 920 and the RFID tags.

### EXAMPLE 2

Example 2 will be described next. A case in which the above-described offset is used will be described below. User data include not only image data but also common data such as a slip number that is small in amount but important. Using an offset enables to store such an important portion in all RFID tags.

For example, user data 930 as shown in FIG. 12A is used. The user data 930 includes a slip number (100 bytes) and image data (5000 bytes).

First, the pharmaceutical company system 916 receives order information. In Example 2 as well, assume that the store gives an order for five medicaments. The pharmaceutical company 901 prepares the five medicaments 903 of the order and applies the RFID tag 904 to each medicament. The tag ID of each RFID tag 904 is tag ID information shown in FIG. 12B. The pharmaceutical company system 916 generates the user data 930 based on the RFID tags 904 and the order information.

In Example 2, the user data 930 is 5100-byte data including the slip number and the image data of the slip, as described above. The pharmaceutical company system 916 needs to link the RFID tags 904 with the user data 930 to manage the medicaments. For this purpose, the pharmaceutical company system 916 notifies the control device 912 of the tag IDs of the RFID tags 904 and the user data 930.

The data control unit 913 of the control device 912 reads out setting information shown in, for example, FIG. 13 from the setting registration unit 914 and calculates the division number s, rotation length r, and offset length o. In Example 2, the number of RFID tags is five. The data size of the user data 930 is 5,100 bytes. Set values set in the setting registration unit 914 are s=5, r=1000, and o=100.

Next, compressed data is created. Compressed data is created using data area information registered in the setting registration unit 914. In Example 2, Region 0 where the slip number has a size of 100 bytes and uses lossless method A, region A uses lossless method A, and region B uses lossy method B. By calculation, s=5, r=1000, o=100, A=20%, and B=80% are obtained.

The compressed data are generated equal in number to the division number. In Example 2 as well, five compressed data sets are generated, as shown in FIG. 12C. In Example 2, however, each compressed data also includes region 0 corresponding to the slip number.

Header information corresponding to each compressed data is created. The Header information includes the division number, rotation length, offset length, and original user data size. These pieces of information are used to reconstruct compressed data. In Example 2, Header 1 includes s=5, r=0, o=100, L=5000, size o′ of RF(0), n′=data size of RF(T1), and m′=data size of IF(T2+T3+T4+T5). Compressed data 1 to 5 including Header 1 to 5 correspond to the above-described tag storage user data. Note that as described above, if comparison between compressed data and original data reveals that the compressed data is larger than the original data, the original data is used as the compressed data.

Next, to distributively store the created compressed data 1 to 5 in the RFID tags 904, a write RFID tag information list which sequentially associates compressed data 1 to 5 with the RFID tags 904 is created. In Example 2, to distributively store the compressed data in the RFID tags 904, a write RFID tag information list as shown in FIG. 12D is created.

The created write RFID tag information list is sent to the RW control unit 915. The RW control unit 915 detects the tag IDs in the write RFID tag information list and writes compressed data 1 to 5 in the corresponding RFID tags 904. In Example 2 as well, five RFID tags 904 are used, and compressed data 1 to 5 are written in their user memories (not shown), respectively. In Example 2, the information of the offset portion is written in all the five RFTD tags 904.

Data reconstruction in the store 902 which receives the medicaments 903 with the RFID tags 904 in which compressed data 1 to 5 have been written in the above-described way will be described next. First, when the medicaments 903 shipped by the pharmaceutical company 901 have arrived at the store 902, warehousing of the medicaments 903 is confirmed. When the medicaments 903 are warehoused, the RW 921 detects the RFID tag 904 within the radio wave range. Upon detecting an RFID tag, the RW 921 notifies the control device 922 of the tag ID of the detected RFID tag 904.

The RW control unit 925 of the control device 922 instructs the RW 921 to read-access the user memory of the RFID tag 904 using the received tag ID. In Example 2, the user memories of the five RFID tags 904 store compressed data 1 to 5. The RW 921 reads out these data and notifies the RW control unit 925 of them.

The RW control unit 925 puts the acquired tag IDs and readout compressed data 1 to 5 together to create a read RFID tag information list and notifies the data control unit 923 of it. In Example 2, the created read RFID tag information list is the same as the write RFID tag information list shown in FIG. 12D.

The data control unit 923 analyzes all compressed data in the write RFID tag information list and reconstructs them. At this time, the data control unit 923 also checks the size of the offset. The data control unit 923 acquires the division number s, rotation length r, offset length o, size n′ of region A, size m′ of region B, and original data size L from Header 1 to 5 of compressed data 1 to 5. For example, information of Header 1 includes s=5, r=0, o=100, n′=n1, m′=m1, and L=5000.

Next, compressed data 1 is reconstructed using the analyzed information of Header 1. In Example 2, compressed data RF(T1) of the offset region and region A is reconstructed to T1 by lossless method A. Compressed data IF(T2+T3+T4+T5) of region B is reconstructed by lossy method B. However, since lossy method B cannot completely reconstruct original data, (T2+T3+T4+T5)′ is obtained.

After that, the original user data 930 is reconstructed, and the control device notifies the store system 926 of the information of the reconstructed user data 930 and the RFID tags, as described above. In Example 2, the slip number in the offset region is completely reconstructed and sent to the store system 926. The slip number is used when checking reception of the medicaments 903.

According to Example 2 described above, the following effects can be obtained. As the first effect, the amount and time of communication between each RFID tag and the RW can further be reduced. Minimum data (only offset) out of a large-quantity of data is usually read out and used for check or the like. The remaining information can be read out from the user memory of the RFID tag and used as needed.

For example, normally, check is done using only the slip number or the like in the offset for warehousing. When detailed image data of the slip or the like is necessary for printing, the RF(T) portion is read out from the user memory of the RFID tag again so as to use all data.

As the second effect, problem detection is easy. The offset portions of a RFID tag group of a certain unit store identical data. If one of detected RFID tags has different offset data belonging to a different group, the problem can easily be detected.

For example, if only one of five RFID tags has a different offset, the tag may be of an article that has been packaged wrong. This can be detected without reading out all user data.

### EXAMPLE 3

Example 3 will be described next. In Example 3, a method of storing user data without repetition so as to detect an error will be explained. The most part of Example 3 is the same as in Example 2 described above. In Example 3, processing to be executed when the medicaments 903 that have arrived at the store 902 are short will be described. For example, in case of shortage, any of compressed data 1 to 5 cannot be acquired, and the user data 930 cannot completely be reconstructed. Detecting that the user data 930 cannot completely be reconstructed allows the user to recognize the presence of shortage. For example, if the user data 930 cannot completely be reconstructed, the data control unit 923 notifies the store system 926 of the error state. By the notification, the store system 926 receives RFID tag information, incomplete user data, and information representing the error state. This enables the store system 926 to detect the shortage state.

According to the above-described present invention, a large quantity of data is divided, and the divided data are compressed and distributively stored. This allows to reduce the amount and time of communication between the reader/writer and an RFID tag. Hence, even when the RFID tags are enormous in number, necessary information can be obtained in short time.

As described above, regions A and B are divided: Even when no information can be obtained from one of the RFID tags, and divided and distributed data are short, user data, though incomplete, can be acquired. For example, even when no information can be obtained from one RFID ‘tag, incomplete user data such as a partially coarse slip image can be acquired. Image data generally suffers no serious problem even if it is partially coarse (incomplete), and practical processing can sufficiently be performed.

As described above, when regions A and B are divided, user data, though incomplete, can be used even if only one RFID tag is available. In this case, since all RFID tags store overview information of user data, the user data is usable. For example, when user data is divided into 100 pieces, one RFID tag stores complete data (region A) representing 1% of the user data and incomplete data (region B) representing 99% of the user data. This means coarse image data of the designated user data.

As a utilization for except warehousing/retrieval, when a clerk confirms the name or overview information of an article to confirm article information in the store, even coarse image data is often satisfactory and sufficiently useful as such.

As described above, according to the present invention, it is also possible to detect shortage of articles. If data is partially short upon user data reconstruction, shortage of articles can be detected. Hence, the system can detect the problem without performing complex analysis such as user data or tag ID analysis and perform the confirmation operation at that point of time. If a problem is detected, the short article can immediately be specified based on the partially incomplete reconstructed user data.

The user data area may be divided into three or more pieces. In the above-described examples, user data is divided into two parts, that is, region A and region B. However, the present invention is not limited to this. The division number and method are not particularly limited if the number is one or more. However, when compressing the divided data, at least one region always needs to be compressed by a lossless method.

For example, the number of regions may be increased to form region C, region D, and the like in addition regions A and B. The compression method may also combine method C and method D. This makes it possible to apply the most appropriate compression region and method based on the user data characteristic and thus obtain divided compressed data at a higher compression ratio. Generating smaller data in this way allows to further reduce the amount and time of communication.

In RW setting, the user memory read method may be changed. Optimizing the read method allows to further reduce the amount and time of communication. For example, when the user memories of s RFID tags are read first, and user data can completely be reconstructed at that point of time, only tag IDs may be read out from the remaining RFID tags by changing RW control. Alternatively, a data ID may be stored in Header information, and the RW may dynamically controlled such that when all losslessly compressed regions are available, only Header information is read out, and when the data IDs are identical, the remaining user memories are not read-accessed.

The division number s may be changed to an arbitrary value. In the exemplary embodiments, the division number s equals the number of RFID tags. Instead, the division number s may be, for example, (number of RFID tags/2). In this case, identical divided compressed user data are stored in two RFID tags. The data is redundant. For this reason, even in case of shortage of one tag, the user data can completely be reconstructed using at least one RFID tag holding the same data.

The rotation length r may be changed to an arbitrary value. In the exemplary embodiments, the rotation length is defined as (user data size/division number) x i. Instead, an arbitrary value or formula may be used. If the rotation length r causes regions A to overlap, the redundant data is distributed to a plurality of RFID tags. It is therefore possible to increase the reliability of data reconstruction.

In the above description, RFID tags are used. However, the present invention is applicable when there are a plurality of devices having a storage area. For example, the present invention can also be practiced for IC cards, sensors with memory, two-dimensional barcode, and the like.

Data reconstruction may be prohibited unless all divided compressed data are available. When data reconstruction is prohibited unless all RFID tags are available, the personnel on the site cannot know details of articles, though an error is detectable. This is effective for the sake of security when the user does not want a third party to know details of an article upon using a distribution company or the like.

The present invention has been described above based on the exemplary embodiments. However, the present invention is not limited to the above-described exemplary embodiments. Various changes and modifications understandable by those who skilled in the art can be made for the arrangement and details of the present invention without departing from the spirit and scope thereof.

This application claims the benefit of Japanese Patent Application No. 2008-233059, filed Sep. 11, 2008, which is hereby incorporated by reference herein in its entirety.

1. An IC tag control method comprising at least:
the first step of dividing set original data by a preset division number to generate a plurality of divided data;
the second step of creating a tag information list including a plurality of correspondence relations that associate the divided data with a plurality of preset tag IDs; and
the third step of transmitting all the divided data to IC tags having corresponding tag IDs based on the tag information list.

2. An IC tag control method according to claim 1, further comprising:
the fourth step of, after the third step, receiving the divided data from the IC tags; and
the fifth step of reconstructing the original data by combining all the received divided data.

3. An IC tag control method according to claim 1, wherein in the first step, the divided data is compressed using a preset compression method to generate the divided data.

4. An IC tag control method according to claim 3, further comprising:
the fourth step of, after the third step, receiving the divided data from the IC tags; and
the fifth step of reconstructing the original data by decompressing all the received divided data using a decompression method corresponding to the compression method and combining the divided data.

5. An IC tag control method according to claim 1, wherein in the first step, first compressed data obtained by compressing the divided data using a preset lossless first compression method and second compressed data obtained by compressing remaining data of the original data except the divided data using a preset lossy second compression method are created, and the first compressed data and the second compressed data are included in the divided data.

6. An IC tag control method according to claim 5, further comprising:
the fourth step of, after the third step, receiving the divided data from the IC tags;
the fifth step of reconstructing the original data by separating the first compressed data from all the received divided data, decompressing all the separated first compressed data using a first decompression method corresponding to the first compression method, and combining the divided data; and
the sixth step of generating reconstructed data corresponding to the original data by separating the first compressed data and the second compressed data from the received divided data and combining first decompressed data obtained by decompressing the separated first compressed data using the first decompression method with second decompressed data obtained by decompressing the separated second compressed data using a second decompression method corresponding to the second compression method.

7. An IC tag control apparatus comprising at least:
a data processing unit that divides original data set in a setting registration unit by a preset division number to generate a plurality of divided data, and creates a tag information list including a plurality of correspondence relations that associate the divided data with a plurality of preset tag IDs; and
a reader/writer control unit that transmits all the divided data to IC tags having corresponding tag Ds based on the tag information list.

8. An IC tag control apparatus according to claim 7, wherein said reader/writer control unit receives the divided data from the IC tags, and
said data processing unit reconstructs the original data by combining all the divided data received from the IC tags.

9. An IC tag control apparatus according to claim 7, further comprising a compression unit that compresses the divided data using a preset compression method to generate the divided data.

10. An IC tag control apparatus according to claim 9, further comprising:
a decompression unit that decompresses all the received divided data using a decompression method corresponding to the compression method,
wherein said reader/writer control unit means receives the divided data from the IC tags, and
said data processing unit reconstructs the original data by combining all the divided data received from the IC tags and decompressed by said decompression unit means.

11. An IC tag control apparatus according to claim 7, further comprising a compression unit that creates first compressed data by compressing the divided data using a preset lossless first compression method and second compressed data by compressing remaining data of the original data except the divided data using a preset lossy second compression method, and generates the divided data including the first compressed data and the second compressed data.

12. An IC tag control apparatus according to claim 11, further comprising:
a decompression unit that separates the first compressed data from all the received divided data and decompressing all the separated first compressed data using a first decompression method corresponding to the first compression method, and
generates reconstructed data corresponding to the original data by separating the first compressed data and the second compressed data from the received divided data and combining first decompressed data obtained by decompressing the separated first compressed data using the first decompression method with second decompressed data obtained by decompressing the separated second compressed data using a second decompression method corresponding to the second compression method,
wherein said reader/writer control unit receives the divided data from the IC tags, and
said data processing unit means reconstructs the original data by combining the data after said decompression unit has decompressed all the first compressed data using the first decompression method corresponding to the first compression method.

13. An IC tag control apparatus comprising at least:
data processing means for dividing original data set in a setting registration unit by a preset division number to generate a plurality of divided data, and creating a tag information list including a plurality of correspondence relations that associate the divided data with a plurality of preset tag IDs; and
reader/writer control means for transmitting all the divided data to IC tags having corresponding tag IDs based on the tag information list.
